(19) United States
(12) Patent Application Publication
(10) Pub. No.: US 2003/0042088 A1
(43) Pub. Date: Mar. 6, 2003

(54) Force absorption device

(75) Inventors: Christian Braun, Holzkirchen (DE); Johann Distl, Unterhaching (DE)

Correspondence Address: PEARNE & GORDON LLP, 526 SUPERIOR AVENUE EAST, SUITE 1200, CLEVELAND, OH, 44114-1484, US

(73) Assignee: Maurer Sohne GmbH & Co. KG

(21) Appl. No.: 10/227,924

(22) Filed: Aug. 26, 2002

(30) Foreign Application Priority Data
Aug. 31, 2001 (DE) 101 42 709.3

(51) Int. Cl. F16F 9/00

(52) U.S. Cl. 188/314

(57) ABSTRACT

A force absorption device is proposed which serves for receiving and diverting forces in bridge constructions in particular. Said device includes a housing (2) with at least one hydraulic liquid chamber (5). In said hydraulic liquid chamber (5) a movable hydraulic piston (3) is supported which is guided by a piston rod (4). In this manner forces acting on said hydraulic piston (3) are transmitted to said hydraulic liquid. In addition at least one compensation chamber (11) connected to said hydraulic liquid chamber (5) and filled with hydraulic liquid is provided for, which chamber can be changed in its volume in dependence on the density of said hydraulic liquid. Therein, said piston rod (4) at least partly is build in hollow shape for forming said compensation chamber (11) in the interior of said housing (2) and/or in said piston rod (4).

### BACKGROUND OF THE INVENTION

The present invention relates to a force absorption device as defined in the preamble of patent claim 1. Such force absorption devices is used in bridge construction particular, for receiving and diverting forces.

In the construction of bridges in earthquake regions generally force absorption devices which either work as blocking system, i.e. only force is transmitted thereto, or a buffering system, i.e. force impacts in addition are damped, are provided for between the bridge and the bridge pier and/or the abutment, respectively. The principle under which such force absorption devices work is based on the conversion of kinetic impact energy into thermal energy, the impact energy therein being transmitted to the hydraulic liquid bath via an hydraulic piston supported in an hydraulic liquid bath. Hereby heating of the hydraulic liquid and the absorption or buffering of impacts is effected.

Heating of the hydraulic liquid bath in case of impacts results in expansion of the hydraulic liquid. Furthermore, the ambient air also causes heating and expansion of the hydraulic liquid. Therefore, in such force absorption devices compensation chambers have to be created which permit expansion of the hydraulic liquid. Such compensation chambers in the devices under prior art are provided for outside of the hydraulic piston or the piston rod guiding said hydraulic piston. This, however, includes the disadvantage that such compensation chambers can easily be damaged by outside influence, e.g. vandalism, and that they require additional room in the overall system.

### SUMMARY OF THE INVENTION

It is, therefore, the object of the present invention to create a force absorption device which is protected against damage and which is very compact in its construction.

This object is solved by the force absorption device in accordance with the independent claim 1. Preferred embodiments of the invention are defined in the depending claims.

The force absorption device in accordance with the present invention includes a housing with at least one hydraulic liquid chamber, a movable hydraulic piston being guided by a piston rod, being supported in said hydraulic liquid chamber. The forces acting on said hydraulic piston therein can be transmitted to said hydraulic liquid. Said device further includes at least one compensation chamber connected to said hydraulic liquid chamber and filled with hydraulic liquid and which can be changed in terms of volume depending on the density of said hydraulic liquid. In the device in accordance with the present invention said piston rod therein at least partly is built as hollow shape, said compensation chamber thereby being created in the inside of the housing and/or in said piston rod. Said compensation chamber thus in essentially lower degree is exposed to damage by external influences, as it is located in the inner region of said housing. Since in addition in the inside of the housing a hollow space which is left unutilized in the known force absorption devices is created for formation of said compensation chamber, the device in accordance with the present invention is much more compact in its construction. Moreover, the force absorption device in accordance with the present invention permits formation of said hollow space in a part of said piston rod, which is not charged neither by pressure nor by tension so that a hollow space in said piston rod does not cause losses in loading capacity of said force absorption device either.

In a preferred embodiment of the invention the compensation chamber is provided for in the very piston rod itself. Thus, said compensation chamber is completely decoupled from said housing, this guaranteeing a particularly good protection against external influences.

In another embodiment the piston rod and the hydraulic piston are guided on an essentially hollow inner tube and the compensation chamber includes a hollow space in said inner tube. By this construction it is achieved as further advantage that the amount in hydraulic liquid can be reduced substantially, since the hydraulic liquid chamber essentially is formed by the gap between said hollow inner tube and said housing of the device and this is highly reduced in its volume.

In another embodiment of the invention the change in volume of the compensation chamber is effected by a second displaceable piston or a diaphragm cushion which preferably is charged with gas pressure from one side. As far as in the following reference is made to the second displaceable piston, such references is to also include a diaphragm cushion. The gas pressure is generated e.g. in that a loading chamber is provided for in one end of the device, said loading chamber being filled with the gas for generating said gas pressure.

In order to permit that the force absorption device automatically returns from the buckled condition into normal condition, in a preferred embodiment the loading chamber is constructed such that the gas pressure can shift the piston rod for generation of a restoring force.

In the embodiment of the device, in which the compensation chamber includes a hollow space in the piston rod, also the loading chamber can at least partly be formed by an area of said hollow space in said piston rod.

In the embodiment in which the piston rod is guided in a hollow inner tube, the loading chamber can include a hollow space in the inner tube and in addition also a hollow space in said piston rod.

Instead of generating a restoring force by means of gas pressure and/or for amplification of the restoring force, the front and back sides of the hydraulic piston can show different surfaces. As the pressures on both surfaces of the hydraulic piston are equal, this causes a resulting force directed from the side of the piston with the larger surface to the side of the piston with the smaller surface.

For providing for a fluid connection between the compensation chamber and the hydraulic chamber, these two chamber preferably are mutually connected by a bore and/or a valve.

Preferably at least one bore and/or a valve, which connect the front and back sides of said hydraulic piston with one another and through which hydraulic liquid flows when impact forces are exerted on said device, are provided for in the hydraulic piston.

In another preferred embodiment a sensor device permitting detection of the position of the hydraulic piston and/or the second piston is provided for in said force absorption device. This sensor device in a preferred embodiment of the invention consists of at least one first sensor rod protruding into the interior of the piston rod and a first induction coil arranged on one end of the piston rod and movable with respect to the first sensor rod. By the motion of the first induction coil in relation to the first sensor rod due to the reciprocating movement of the hydraulic piston an electrical signal permitting to detect the position of the hydraulic piston is induced in the coil.

Beside a first sensor rod and a first induction coil in addition a second sensor rod arranged in the interior of the piston rod and at least one second induction coil arranged in the second piston and movable with respect to the second sensor rod can be provided for. The second induction coil therein is displaced with respect to the second sensor rod, when the second piston moves. Thereby, an electrical voltage permitting to detect the position of the second piston is induced in the induction coil.

In a further embodiment of the sensor device therein the first and second sensor rods are mutually connected in telescopic manner. Instead of providing for movable induction coils in relation to the sensor rods, the induction coils can also be integrated into the sensor rod, and position detection of the hydraulic piston and/or the second piston can be effected using a magnet, e.g. a permanent magnet, said permanent magnet therein being movable in relation to the sensor rods.

By the sensor device it is rendered possible to detect the position of the hydraulic piston as well as the position of the second piston, and thus statements can be given on the loading condition of the buffer and the present effect of the buffer. The sensor device thus permits a control of the condition of the force absorption device as well as of the building itself.

### BRIEF DESCRIPTION OF DRAWINGS

Further features and details of the invention become evident from the following detailed description of preferred embodiments with reference to the attached drawing, wherein

FIG. 1 shows a cut view of a first embodiment of the force absorption device in accordance with the present invention;

FIG. 1A shows a cut view of a modification of the hydraulic piston shown in FIG. 1, and the piston rod connected thereto;

FIG. 2 shows a cut view of a second embodiment of the force absorption device in accordance with the present invention;

FIG. 2A shows a cut detail view of the area of the cover 20 of FIG. 2;

FIG. 3 shows a sectional view of a third embodiment of the force absorption device in accordance with the present invention;

FIG. 4 shows a sectional view of a fourth embodiment of the force absorption device in accordance with the present invention.

### DETAILED DESCRIPTION OF PREFERRED EMBODIMENT

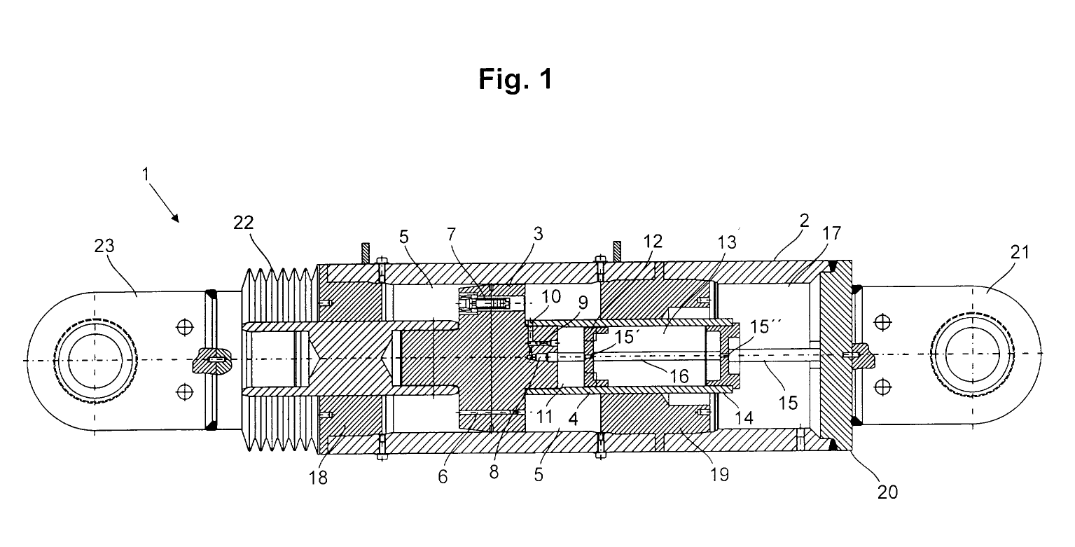

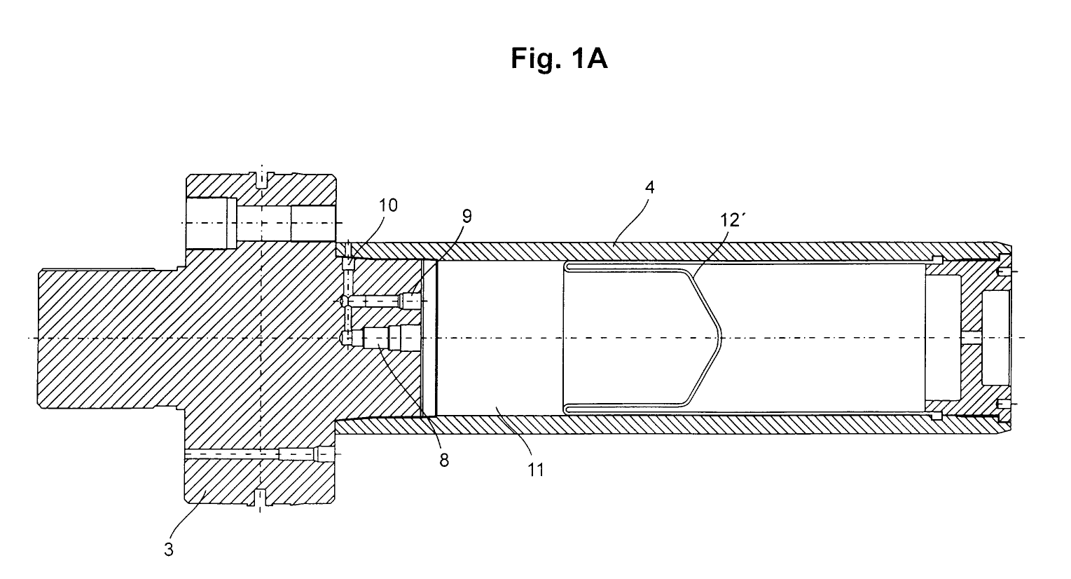

The embodiment of the force absorption device in accordance with the present invention, as shown in FIG. 1 shows a buffer 1 which is in particular used in bridge construction between bridge and abutment and/or pier and preferably is used in earthquake regions for damping earth quake tremor. Said earthquake buffer includes a cylindrical housing 2 which on its both ends is limited by cylinder covers 18 and 20. In said housing a hydraulic piston 3 is supported in a hydraulic oil bath 5. Said hydraulic piston on its both ends is connected to a piston rod 4. Said piston rod on one end is guided in said cylinder cover 18 and on the other end in a cylinder cover 19 located in said housing. Said piston in its outer area comprises a through bore 6 as well as a pressure control valve 7. In case of an earthquake pressure is exerted onto one side of said piston rod, this causing a movement of said hydraulic piston in the oil bath 5. This again results in that the oil is pressed through said bore 6 and said pressure control valve 7. Thereby, the kinetic impact energy is converted into thermal energy, i.e. the oil is heated when passing through said bore and said pressure control valve. The heat produced by the two operations just described causes expansion of the oil. For permitting such expansion of the oil, the portion of said piston rod guided in said cylinder cover 19 is built like a hollow shape. Said hollow space includes a compensation chamber 11 filled with oil, connected to said oil bath 5 via a valve 8, a filter 9 and a bore 10. Said compensation chamber 11 is closed by a movable gas piston 12, said piston being adjacent to a chamber 13 filled with gas, which also is formed by the hollow space in said piston rod. Said loading chamber 13 is closed by a cover 14. An expansion of the hydraulic oil thus causes enlargement of the volume of said compensation chamber 11 and thus causes displacement of said gas piston 12 against the gas pressure in said loading chamber.

In FIG. 1A a modification of the embodiment of the hydraulic piston shown in FIG. 1 and the piston rod connected thereto is shown. The only difference to FIG. 1 lies in that instead of a movable gas piston 12 a diaphragm cushion 12 is provided for changing the volume of said compensation chamber 11.

When said buffer shown in FIG. 1 is compressed in result of an impact, it subsequently will not move back into its original position. The reason is that the front faces of said piston located in said oil bath are of the same size and thus the forces acting on said piston are identical on both sides of said piston. The gas provided for in said piston rod 4 does not cause displacement of said piston rod because it is enclosed in said piston rod by means of the cover 14 and thus presses on said oil only.

By a minor modification of said buffer from FIG. 1 it can be caused that said buffer has a centering function, i.e. that it automatically returns from its buckled condition into its original condition. The constructional amendment lies in that said cover 14 is omitted and said empty space 17 is sealed to the outside by a gas loading valve. This results in that the gas now is present not only in said loading chamber 13 but also in said empty space 17 adjacent to said cover 20. Thereby the gas pressure can displace said piston rod 4 and thus said hydraulic piston 3. After said buffer was buckled by an impact, the gas presses said piston rod and said hydraulic piston back into their original positions.

The buffer shown in FIG. 1 further includes a sensor device for detecting the position of the movable gas piston 12 as well as the position of said hydraulic piston 3. Said sensor device consists of a first sensor rod 15 and a second sensor rod 16. Said first sensor rod extends from said cover 15 through said empty space 17 to said cover 20. Said second sensor rod extends from the one first side of said hydraulic piston through said gas piston 12 to said cover 14. Both sensor rods preferably are mutually connected in telescopic manner. Said first sensor rod 15 cooperates with an induction coil 15′ in said cover 14. By the movement of said piston 3 said induction coil 15′ is moved along said sensor rod 15, this causing induction of a current and generation of a measurement signal for detecting the position of said piston. In the same manner said second sensor rod 16 cooperates with an induction coil 16′ provided for in said gas piston 12. By the movement of said gas piston along said sensor rod 16 current is induced in said coil so that a measurement signal for detecting the position of said gas piston is generated. By said measurement signals the filling condition of said buffer, the present effect of said buffer as well as the condition of the building can be detected and checked.

For fixation of said buffer in the building, said housing 2 on its front faces is connected to joint heads 21 and 23 respectively, which again are connected to said bridge and/or said bridge abutment. In addition expansion bellows 22 expanding or contracting in correspondence with the movement of said piston rod, are provided for between joint head 23 and cylinder cover 18.

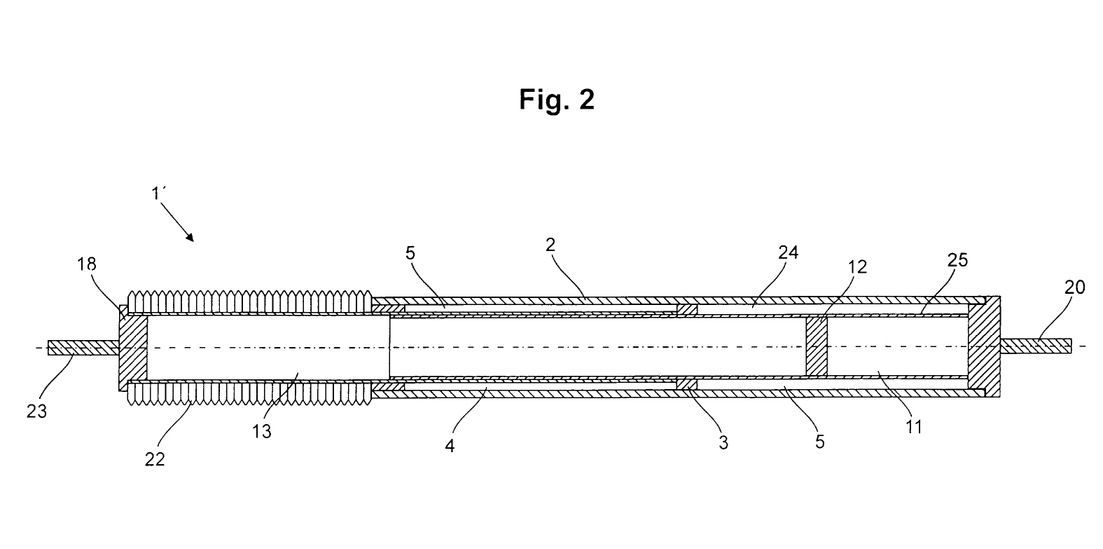

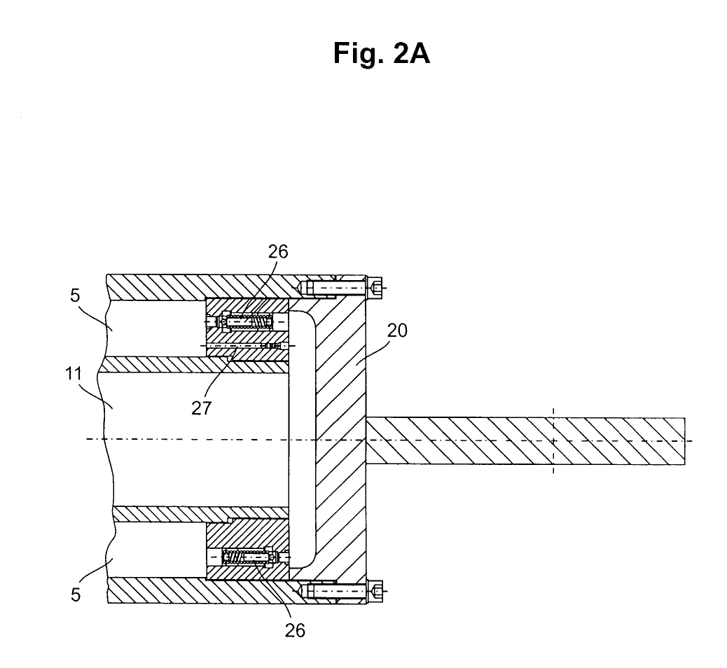

In FIG. 2 a modification of said earthquake damper under FIG. 1 is shown. The components in FIG. 2, corresponding to those in FIG. 1, therein are provided with identical reference numerals. The functional principle of the buffer 1′ of FIG. 2 is the same as in FIG. 1. In difference to FIG. 1, however, the hydraulic piston consists of a cylindrical ring 3 connected to a hollow piston rod 4, said piston rod being guided on a hollow inner tube 24. Said piston again is located in an hydraulic bath 5 which for the larger part is formed by the annular gap between said housing 2 and said piston rod 4 and/or said inner tube 24, respectively. Said gas piston 12 is guided in said inner tube 24, said buffer in said loading chamber 13 being filled with gas under a pressure of 50 bar approximately. Said gas presses against said gas piston 12. Said loading chamber therein extends from the one end of said housing into said inner tube 24 until said gas piston 12 and is sealed by said cover 18. On the side of said gas piston 12, located opposite to said loading chamber the compensation chamber 11 is located which is connected to said oil bath 5 through bores 25 in said inner tube as well as through valves (not to be seen from FIG. 2) and bores in the area of said cover 20. When the oil expands due to heating, said compensation chamber 11 becomes larger so that said piston 12 is displaced against the gas pressure.

Said buffer shown in FIG. 2 also comprises a restoring function, because the gas in said loading chamber 13 displaces said piston rod 4 and thus said hydraulic piston 3. This has the effect that a buckled piston returns into its original position.

In order to effect a displacement of said piston rod 4 and said hydraulic piston 3 it is necessary that a connection exists between said compensation chamber 11 and said oil bath 5. As already mentioned earlier, valves and bores in the area of said cover 20 serve for this purpose. From FIG. 2A showing a detailed view in the cover area of FIG. 2, such valves 16 or a bore 27, respectively, can be seen which permit liquid movement between said compensation chamber 11 and said oil chamber 5.

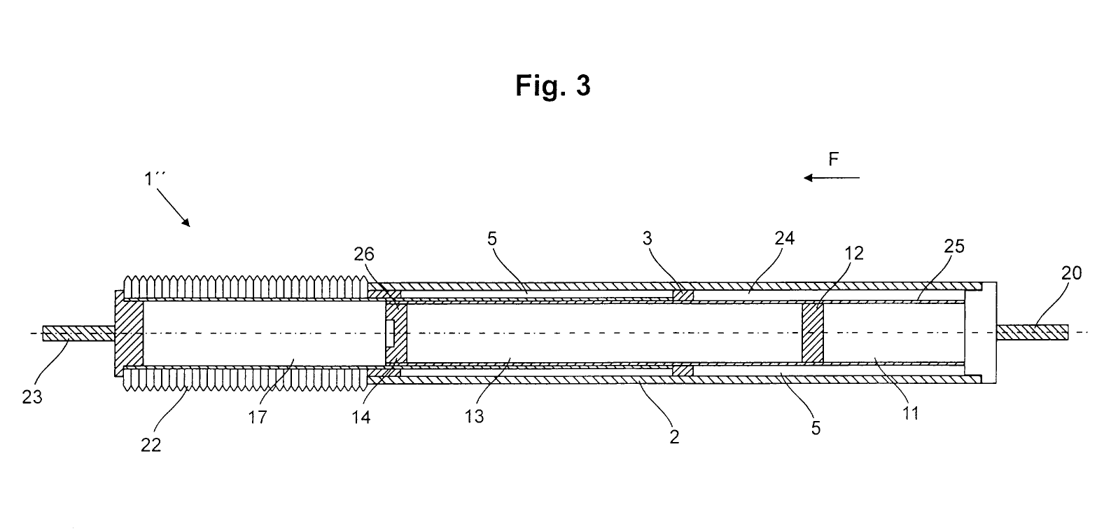

In FIG. 3 an earthquake buffer 1″ is shown which essentially corresponds to said earthquake buffer from FIG. 2. The only difference lies in that in said earthquake buffer from FIG. 3 a further cover 26 is provided for which limits said gas loading chamber 13 so that said loading chamber only is formed between the end of said inner tube 24 and said gas piston 12. This results in that the gas pressure causes an essentially smaller restoring force as compared to the embodiment of FIG. 2. The restoring function of said buffer in FIG. 3 therein is effected in that the surfaces of the front faces of said hydraulic piston, contacting the oil in said hydraulic oil bath are of different size. This results in that the forces exerted on each front face are of different magnitude so that a resulting force F in direction from the front face with larger surface to the front face with smaller surface is generated, which force causes restoration of said buffer. As already mentioned earlier, said restoring force, however, is much smaller than the restoring force in the embodiment of said earthquake buffer under FIG. 2.

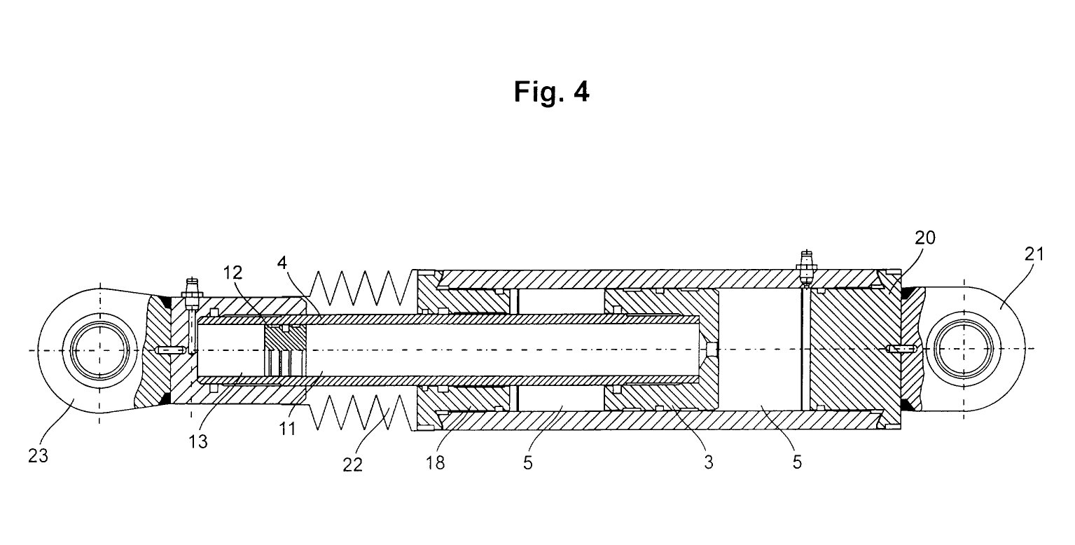

The embodiment of an earthquake buffer shown in FIG. 4 differs from the other embodiments in that said piston rod is made integral and is not divided into two sections by said hydraulic piston 3. Said hydraulic piston in the embodiment of FIG. is provided for on the right-hand side end of said piston rod and said compensation chamber 11 is formed in a hollow space in said force-bearing piston rod. Said hollow space in said piston rod 4 therein like in the other embodiments is separated from a gas loading chamber 13 which is provided for on the left-hand end of said piston rod, via a displaceable gas piston 12. In difference to the remaining embodiments, said compensation chamber thus partly also is located outside of said housing of said earthquake buffer.

What is claimed:

1. A force absorption device, for receiving and diverting forces in bridge constructions in particular, including:
a housing (2) with at least one hydraulic liquid chamber (5);
a movable hydraulic piston (3) supported in said hydraulic liquid chamber (5), which piston is guided by a piston rod (4), forces acting on said hydraulic piston (3) therein being transferable to said hydraulic liquid; and
at least one compensation chamber (11) connected to said hydraulic liquid chamber (5) and filled with hydraulic liquid, which chamber is changeable in its volume in dependence on the density of said hydraulic liquid,
wherein said piston rod (4) at least partly is constructed like a hollow space for formation of said compensation chamber (11) in the interior of said housing (2) and/or in said piston rod (4).

2. The device as defined in claim 1,
wherein said compensation chamber (11) includes a hollow space in said piston rod (4).

3. Said device as defined in claim 1,
wherein said piston rod (4) and said hydraulic piston (3) are guided on an essentially hollow inner tube (24) and said compensation chamber (11) includes a hollow space in said inner tube (24).

4. The device as defined in one of the preceding claims,
wherein said compensation chamber (11) is limited by a second displaceable piston (12) or a diaphragm cushion (12′).

5. The device as defined in claim 4,
wherein said second piston (12) is charged with gas pressure from the one side.

6. The device as defined in claim 5,
wherein a loading chamber (13) which is filled with the gas for generating said gas pressure, is provided for on one end of said device.

7. The device as claimed in claim 6,
wherein said loading chamber is constructed such that said gas pressure can displace said piston rod (4) for generation of a restoring force.

8. The device as claimed in one of the preceding claims,
wherein said loading chamber (13) includes a hollow space in said piston rod (4).

9. The device as defined in claim 3 or one of the claims 4 to 7 in dependence on claim 3,
wherein said loading chamber (13) includes a hollow space in said inner tube (24).

10. The device as defined in one of the preceding claims,
wherein the front and back sides of said hydraulic piston (3) have different surfaces for formation of a restoring force.

11. The device as defined in one of the preceding claims,
wherein said compensation chamber (11) and said hydraulic liquid chamber (5) are mutually connected by at least one bore (10) and/or a valve (8).

12. The device as defined in one of the preceding claims,
wherein said hydraulic piston (3) comprises at least one bore (6) and/or a valve (7), mutually connecting the front and back faces of said hydraulic piston (7).

13. The device as defined in claim 4 or one of the claims 5 to 12 in dependence on claim 4,
wherein a sensor device for detecting the position of said hydraulic piston (3) and/or said second piston (12) is provided for.

14. The device as claimed in claim 3,
wherein said sensor device includes at least one first sensor rod (15) protruding into the interior of said piston rod (4) and a first induction coil (15′) arranged on the one end of said piston rod and movable in relation to said first sensor rod (15), said first sensor rod (15) and said first induction coil (15′) cooperating such that the position of said hydraulic piston can be detected.

15. The device as defined in claim 13 or 15,
wherein said device includes at least one second sensor rod (16) arranged in the interior of said piston rod (4) and at least one second induction coil (16′) arranged in said second piston (12) and movable in relation to said second sensor rod (16), said second sensor rod (16) and said second induction coil (16′) cooperating such that the position of said second piston (12) can be detected.

16. The device as defined in claim 13,
wherein said device includes at least one first sensor rod (15) protruding into the interior of said piston rod (4), with a first induction coil integrated in said sensor rod (15) as well as first magnet arranged on one end of said piston rod and movable in relation to said first sensor rod (15), said first induction coil and said first magnet cooperate such that the position of said hydraulic piston can be detected.

17. The device as defined in claim 13 or 16,
wherein said device includes at least one second sensor rod (16) arranged in the interior of said piston rod (4), with a second induction coil integrated into said sensor rod as well as a second magnet arranged in said second piston (12) and movable in relation to said second sensor rod, said second induction coil and said second magnet cooperating such that the position of said second piston (12) can be detected.

18. The device as defined in claim 14 in dependence on claim 15 or claim 17 in dependence on claim 16,
wherein said first and second sensor rods (15, 16) are mutually connected in telescopic manner.
